(19) United States
(12) Patent Application Publication
(10) Pub. No.: US 2011/0198947 A1
(43) Pub. Date: Aug. 18, 2011

(54) Dust cover plate for linear motor

(75) Inventor: Sung-Ying Lin, Taichung City (TW)

(73) Assignee: Hiwin Mikrosystem Corp.

(21) Appl. No.: 12/658,967

(22) Filed: Feb. 17, 2010

(51) Int. Cl. H02K 41/02

(52) U.S. Cl. 310/12.33

(57) ABSTRACT

A dust cover plate for a linear motor is provided. The linear motor has a machine base mounted with a guideway set that carries a sliding block to slide therealong, a stator being settled at one side of the machine base, and a mover including a mover base connected to the sliding block and a block mover core facing the stator. Therein, an accommodating space exists between the mover base and the mover core for receiving the dust cover plate. The dust cover plate has one side fixed to the guideway and extending over the stator and the mover core to prevent external dust or particles from falling between the mover and the stator.

### BACKGROUND OF THE INVENTION

1. Technical Field

The present invention relates to dust cover assemblies applied to linear motors, and more particularly, to a dust cover plate serving to prevent dust or particles form falling into an interval between a mover and a stator of a linear motor.

2. Description of Related Art

Typically, for reducing sliding resistance in a linear motor, an interval is left between a mover and a stator of the linear motor so as to allow smooth sliding of the mover under magnetic induction. Through a period of use, dust and particles tend to accumulate in such an interval and attach to the mover as well as the stator. The dust and particles, accumulating to a certain amount, can rub against the sliding mover and cause additional noise. In some cases, such rub can even wear coils in the mover, affecting the electrical operation of the linear motor.

For protecting the mechanism, there has been proposed a known dust cover to be installed between a mover and a stator of a linear motor, as shown in FIG. 1. The known approach mainly provides two bellows covers 2 at two sides of a mover base 1 for covering the mover and the stator and preventing dust or particles from falling into an interval between the mover and the stator.

However, even when maximally retracted in length, the bellows covers 2 still take a meaningful space, and thus the linear motor may have to be made longer than needed so as to accommodate the bellows covers 2, which necessarily increases the manufacturing cost of the linear motor. On the other hand, after a certain period of use, the bellows covers 2 with their elasticity fatigued may easily be broken or deform.

An alternative conventional dust cover is in the form of a full-coverage metal hood, which is composed of a plurality of overlapped metal hood members steeled around the mover and the stator. As compared with the foregoing bellows cover 2, the full-coverage metal hood is more durable but still has the problem about taking considerable space because the full-coverage metal hood has to cover the whole travel of the mover. It is disadvantageous for the full-coverage metal hood itself for it requires high material and manufacturing costs. In addition, when it is necessary to repair or replace any internal component of the mover or the stator, the metal hood has to be removed before such operation, thus being inconvenient. In short, both the recited conventional dust covers require highly in space and costs and involve complicated overall structures.

### SUMMARY OF THE INVENTION

To remedy the shortcomings of the conventional devices, the present invention provides a dust cover plate for a linear motor.

The linear motor has a machine base mounted with a guideway set that carries a sliding block to slide therealong, a stator being settled at one side of the machine base, and a mover including a mover base connected to the sliding block and a block mover core facing the stator. Therein, an accommodating space exists between the mover base and the mover core for receiving the dust cover plate. The dust cover plate has one side fixed to the guideway and extending over the stator and the mover core to prevent external dust or particles from falling between the mover and the stator.

Since the dust cover plate of the present invention is configured to be directly fixed to the guideway on the machine base, the dust cover plate adaptive to the length of the guideway can be directly assembled to the guideway without the need of changing the structure, configuration or dimensions of the machine base, so the installation is convenient.

The dust cover plate of the present invention is designed to cover the mover core and stator from above, so it does not enclose the mover core and the stator entirely as the conventional device does. Thereby, the dust cover plate allows maintenance, repairmen and cleaning for the linear motor conveniently.

The dust cover plate of the present invention is more durable as compared with the conventional bellows covers that tend to break or deform after long-term use.

The dust cover plate is compact and can be fully received in the accommodating space, thus taking no additional space.

The dust cover plate of the present invention is cost-effective because its manufacturing does not require a large amount of metal material.

The dust cover plate of the present invention has a simple structure that facilitates mass manufacture.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawing, wherein:

FIG. 1 is an applied view of a conventional dust cover assembled to a linear motor;

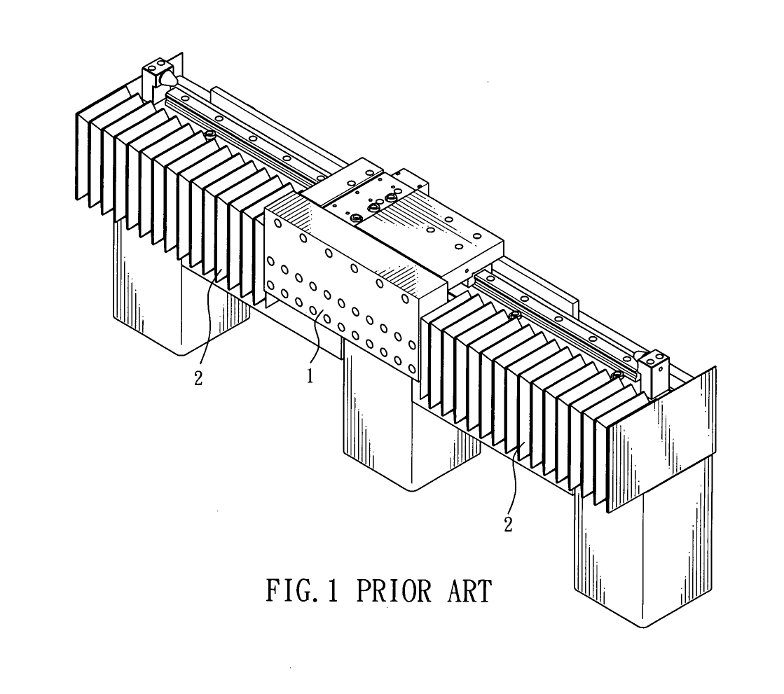

FIG. 2 is an applied view of a dust cover plate of the present invention assembled to a linear motor;

FIG. 3 is an exploded view of FIG. 3; and

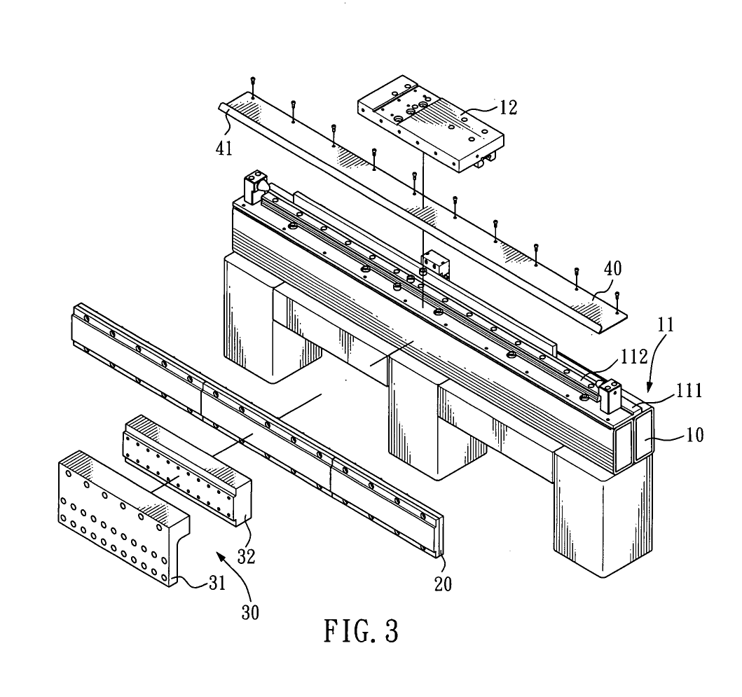

FIG. 4 is a cross-sectional view of FIG. 3.

### DETAILED DESCRIPTION OF THE PREFERRED EMBODIMENT

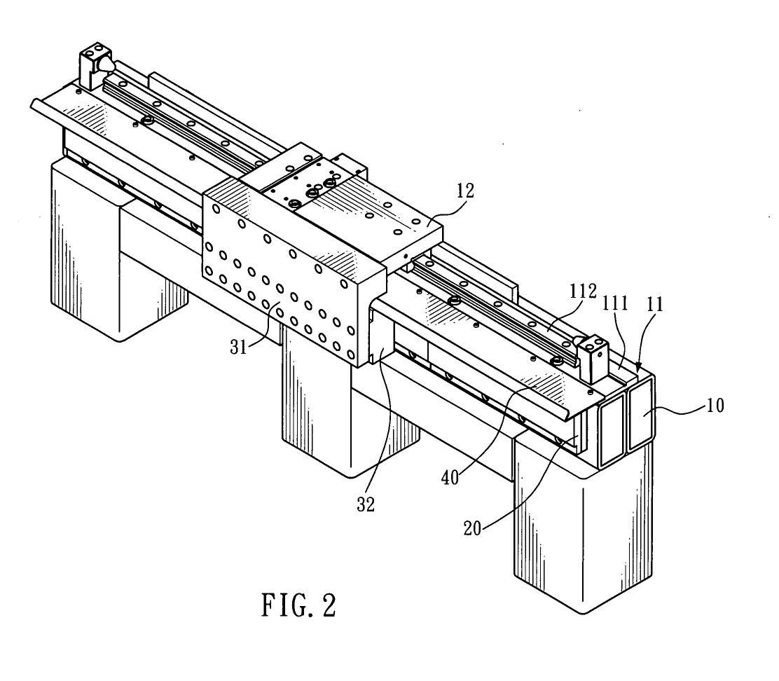

Referring to FIG. 2, the present invention is a dust cover plate for a linear motor. The linear motor mainly includes a machine base 10, a stator 20, and a mover 30. The dust cover plate 40 of the present invention is settled between the stator 20 and the mover 30 for preventing dust.

A guideway set 11 mounted on the machine base 10 has a rail seat 111 and a sliding rail 112. The sliding rail 112 allows a sliding block 12 to slide therealong. The stator 20 is arranged at one side of the machine base 10 and abuts against the rail seat 111.

The mover 30 comprises a reversed-L-shaped mover base 31. The mover base 31 is connected with the sliding block 12 so as to drive the sliding block 12 to move along the sliding rail 112. The mover base 31, at a side facing the stator 20, has a mover core 32. An accommodating space 33 exists between the mover base 31 and the mover core 32. The mover core 32 is adjacent to the stator 20 and has its top surface level with the top surface of the stator 20 while an interval 50 exists between the mover core 32 and the stator 20.

The dust cover plate 40 is a metal sheet or a plastic sheet, with one side fixed to the rail seat 111 and at least extending over the interval 50. The dust cover plate 40 is thus received in the accommodating space 33. An opposite end of the dust cover plate 40, opposite to the side fixed to the rail seat 111, is formed with an upward turned portion 41 over the mover core 32. The upward turned portion 41 serves to block dust or particles out. The dust cover plate 40 is settled slightly higher than the top surfaces of the stator 20 and the mover core 32. For ensuring the dust cover plate 40 completely shielding the mover core 32 and the stator 20 from dust or particles, the dust cover plate 40 preferably has a length equal to or slightly greater than the length of the rail seat 111.

In operation of the linear motor, for example, coils in the mover core 32, in response to magnetic induction, generate a current that interacts with a plurality of magnets in the stator 20 so that the mover core 32 is pushed to slide with respect to the stator 20. Consequently, the mover base 31 drives the sliding block 12 to slide along the sliding rail 112. However, it would be appreciated by people skilled in the art that the present invention is applicable to any known type of linear motors without limitation.

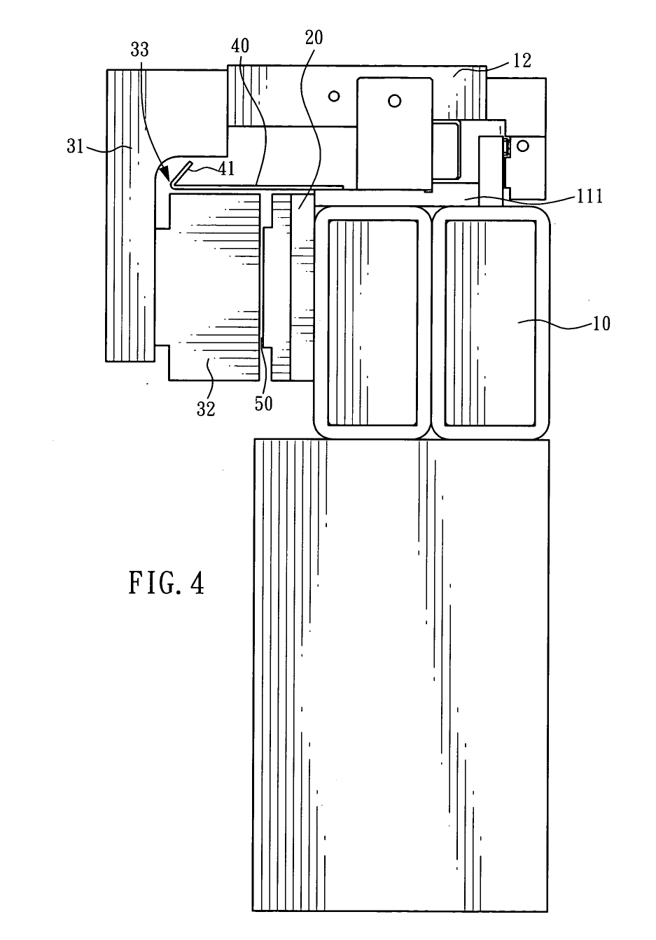

Referring to FIG. 4, the dust cover plate 40 fully covers the mover core 32 and the stator 20 so as to prevent dust or particles from falling into the interval 50 and rubbing against the mover core 32, thereby protecting the coils in the mover core 32 from wearing. Furthermore, the upward turned portion 41 effectively prevents the dust or particles blocked by the dust cover plate 40 from accidentally falling onto the mover core 32 and the upward turned portion 41 also facilitates collection of dust or particles.

As compared with the prior art, the present invention provides at least the following benefits:
1. Since the dust cover plate 40 of the present invention is configured to be directly fixed to the rail seat 111 on the machine base 10, the dust cover plate 40 adaptive to the length of the rail seat 111 can be directly assembled to the rail seat 111 without the need of changing the structure, configuration or dimensions of the machine base 10, so the installation is convenient.
2. The dust cover plate 40 of the present invention is designed to cover the mover core 32 and stator 20 from above, so it does not enclose the mover core 32 and the stator 20 entirely as the conventional device does. Thereby, the dust cover plate 40 allows maintenance, repairmen and cleaning for the linear motor conveniently.
3. The dust cover plate 40 of the present invention is more durable as compared with the conventional bellows covers that tend to break or deform after long-term use.
4. The present invention dust cover plate 40 is compact and can be fully received in the accommodating space 33, thus taking no additional space.
5. The dust cover plate 40 of the present invention is cost-effective because its manufacturing does not require a large amount of metal material.
6. The dust cover plate 40 of the present invention has a simple structure that facilitates mass manufacture.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A dust cover plate for a linear motor, the linear motor having a machine base mounted with a guideway set that carries a sliding block to slide therealong, a stator being settled at one side of the machine base, and a mover including a mover base connected to the sliding block and a block mover core facing the stator, an accommodating space existing between the mover base mover core for receiving the dust cover plate, and the dust cover plate being characterized in:
having one side fixed to the guideway and extending over the stator and the mover core to prevent external dust or particles from falling between the mover and the stator.

2. The dust cover plate of claim 1, wherein the dust cover plate has a side opposite to the side fixed to the guideway formed with an upward turned portion.

3. The dust cover plate of claim 1, wherein the dust cover plate has a length equal to or slightly greater than a length of the rail seat.

4. The dust cover plate of claim 1, wherein the dust cover plate is a metal sheet.

5. The dust cover plate of claim 1, wherein the dust cover plate is a plastic sheet.
